(19) United States
(12) Patent Application Publication
(10) Pub. No.: US 2005/0286641 A1
(43) Pub. Date: Dec. 29, 2005

(54) Finite impulse response de-emphasis with inductive shunt peaking for near-end and far-end signal integrity

(76) Inventor: Jun Cao, Irvine, CA (US)

Correspondence Address: CHRISTIE, PARKER & HALE, LLP, PO BOX 7068, PASADENA, CA, 91109-7068, US

(21) Appl. No.: 10/852,280

(22) Filed: May 24, 2004

(51) Int. Cl. H04B 1/66

(52) U.S. Cl. 375/240.26

(57) ABSTRACT

A finite impulse response (FIR) de-emphasis data driver for a data transmitter or a receiver. The FIR de-emphasis data driver has a first tap having at least one shunt peaking inductor, a second tap and a mixer. The first tap receives a data input, and generates a first output. A second tap receives the first output, and generates a second output. The mixer combines the first output and the second output to generate a driver output. The second tap may also have a shunt peaking inductor. Further, the FIR de-emphasis data driver may include more than two taps.

### FIELD OF THE INVENTION

This invention is related to high-speed data communications, and more particularly to a data driver having an inductive shunt peaking finite impulse response (FIR) de-emphasis to maintain near-end and far-end signal integrity.

### BACKGROUND

A high-speed data driver of a transmitter should be able to ensure signal integrity at both near end and far end of the transmission medium. By way of example, in applications such as Ethernet or storage networks, in which the transmitter is connected to a receiving device through long copper traces on a circuit board, the far-end data integrity is desirable, because larger eye openings that result therefrom correspond to better signal-to-noise ratio. On the other hand, for optical modules, the near-end signal quality is desirable because the laser driver or laser modulator is usually placed close to the data driver. For applications such as computer-to-computer, computer-to-peripheral interconnections, where multi-gigabit-per-second data are sent over different distance ranges, both the near-end and far-end signal integrity is desirable.

Implementing transmission circuitry using relatively inexpensive CMOS technologies results in cost savings and higher integration levels. However, because of relatively low speed of transistors in present CMOS technologies compared with other more expensive processes, it is difficult to transmit very high speed (e.g., multi giga bits per second (Gbps) for the current state-of-art CMOS technology) data over copper traces or fiber.

Therefore, it is desirable to provide a data driver based on CMOS technologies and method that can ensure both near-end and far-end signal integrity.

### SUMMARY

In an exemplary embodiment of the present invention, a finite impulse response (FIR) de-emphasis data driver for a data transmitter or a receiver, is provided. A first tap having at least one shunt peaking inductor receives a data input, and generates a first output. A second tap receives the first output, and generates a second output. A mixer combines the first output and the second output to generate a driver output.

In another exemplary embodiment of the present invention, a method of maintaining near-end and far-end signal integrity of a data transmitter is provided. A data input is received into a first tap having at least one shunt peaking inductor. The first tap generates a first output. A second tap receives the first output, and generates a second output. The first output and the second output are combined to generate a driver output.

These and other aspects of the present invention will be more readily comprehended in view of the discussion herein and accompanying drawings.

### BRIEF DESCRIPTION OF THE DRAWINGS

FIG. 1 is a block diagram of an FIR-based de-emphasis data driver in an exemplary embodiment of the present invention;

FIG. 2 is a block diagram of an FIR-based de-emphasis data driver in another exemplary embodiment of the present invention;

FIG. 3 is a circuit diagram of a latch that can be used to implement the flip-flops for the FIR-based de-emphasis data driver of FIG. 2; and

FIG. 4 is a circuit diagram of a buffer that can be used in the FIR-based de-emphasis data driver of FIG. 2.

### DETAILED DESCRIPTION

Digital filtering technologies, such as FIR-based de-emphasis, are often applied to pre-shape the output pulse from the transmitter to ensure the signal integrity at the far-end. This technique is typically used when the data speed is relatively slow. At those rates, FIR-based de-emphasis can significantly improve the signal quality (i.e., open the data eye) at the far end.

For higher speed communications, because of the additional loading posed to the driver and the flip-flops driving it, FIR-based de-emphasis is usually not used for CMOS circuits running at very high data rate, due to the bandwidth limitation of the conventional CML CMOS analog circuits. Especially for near-end applications (when the de-emphasis is turned-off), the circuit bandwidth is so low due to the additional loading posed by the de-emphasis circuitry. As a result, the data quality (e.g. jitter, rise/fall time) is significantly degraded compared to conventional circuitry without de-emphasis.

Shunt-peaking techniques have been used to enhance the bandwidth of the CMOS analog circuits. Data buffers and flip-flops employing inductive peaking are able to drive heavy capacitive load while providing excellent jitter performance at the near end for data rates as high as 10 Gbps. However, if the data channel is bandwidth limited, the far-end signal quality would still be severely degraded even if the data at the outputs of the drivers is perfect. As a result, high bandwidth channels (such as optical fiber) are required for even medium range transmission of multi-gigabit-per-second data, which significantly increase the cost of the system.

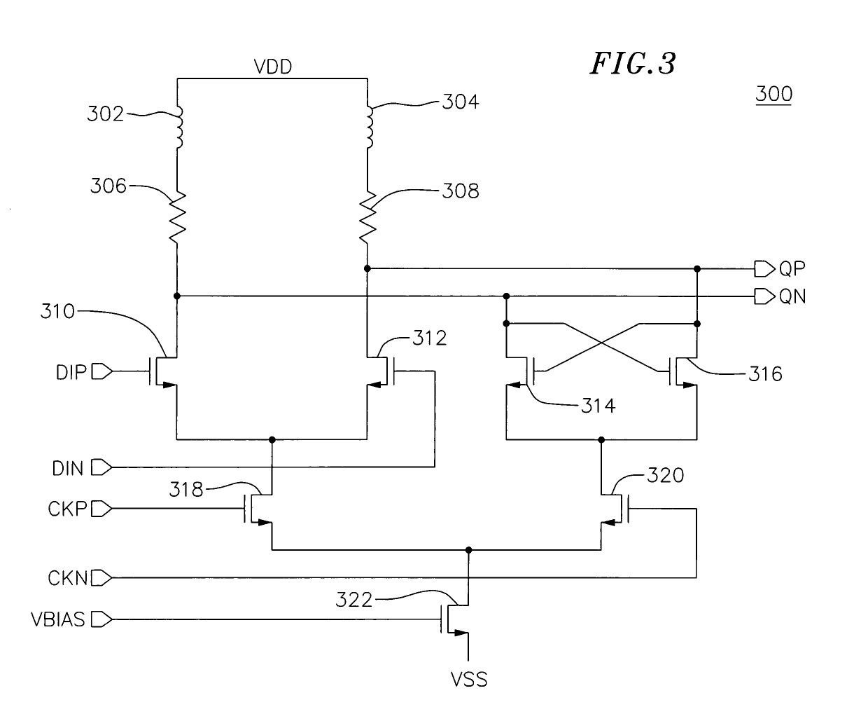

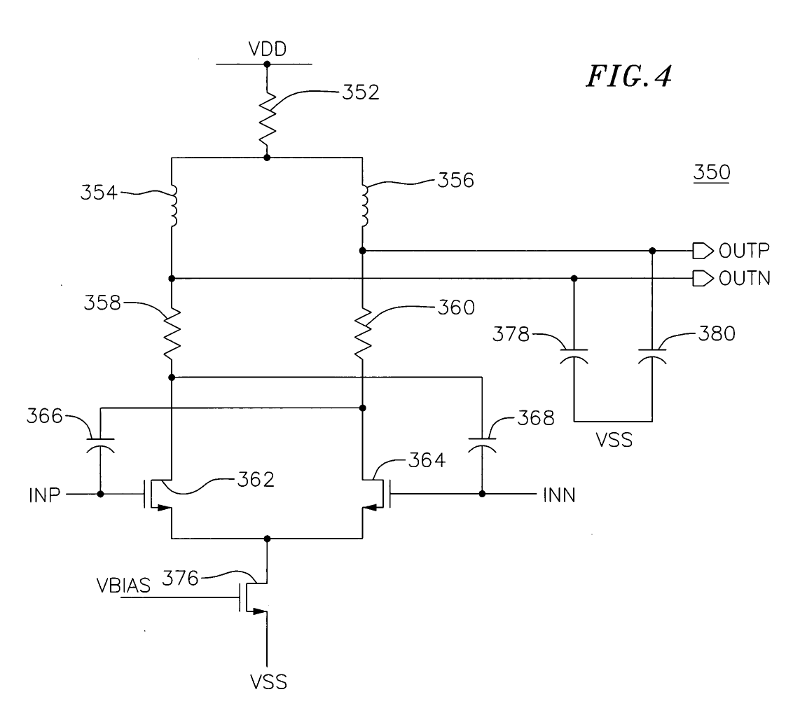

In exemplary embodiments of the present invention, FIR de-emphasis is implemented with inductive shunt peaked pre-driver and flip-flops to utilize the characteristics of both of the technologies so that signal quality at near-end and far-end can be improved. The data taps used to implement the FIR are generated by flip-flops with inductive peaking so that the jitter will be low in subsequent data paths before they reach the final driver. To further increase the driver's capability to drive heavy loadings at the output, the data stream between the flip-flop and the final data driver can be buffered by high bandwidth data buffers with shunt-peaked loads. Circuit examples showing inductive shunt peaking are described in more detail later in reference to FIGS. 3 and 4.

In the exemplary embodiments, signal quality can be significantly improved for high-speed serial data passing through bandwidth-limited channels with various lengths. For near-end applications, de-emphasis can be turned off so that the data quality is determined by the high bandwidth data buffers using shunt-peaking technique. For far-end, de-emphasis can be adjusted to pre-shape the pulse to compensate for the channel loss.

In essence, in exemplary embodiments of the present invention, CMOS wideband technologies are integrated into a de-emphasis architecture to preserve the signal integrity of multi-gigabit data passing through bandwidth-limited channels.

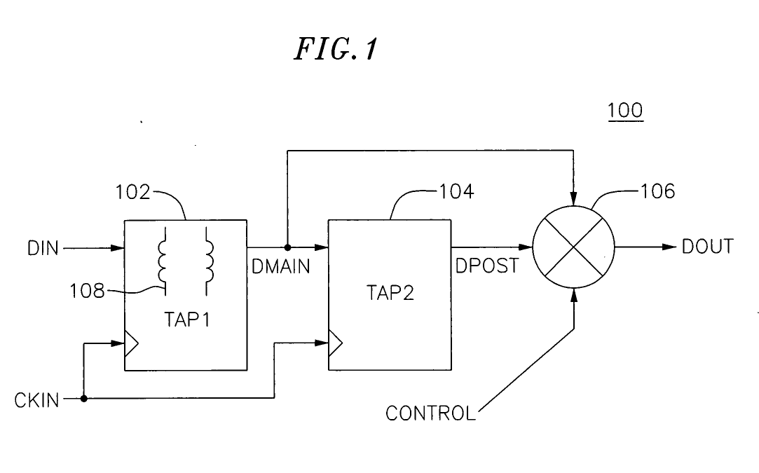

A two-tap FIR de-emphasis data driver 100 with shunt peaking in a first tap 102 in an exemplary embodiment of the present invention is illustrated in FIG. 1. The shunt peaking is provided by a pair of inductors 108 in the first tap 102. The data driver 100 also includes a second tap 104 and a mixer 106. Both the first and second taps 102 and 104 each include a flip-flop. The two-tap shunt-peaked FIR de-emphasis data driver 100 may be used for high-speed applications.

The first tap 102 receives a data input DIN, and provides a DMAIN signal as an output, which is provided to both the second tap 104 and the mixer 106. The second tap 104 receives the DMAIN signal, and outputs a DPOST signal. The DPOST signal is provided to the mixer 106. The mixer 106 is controlled by a control signal to generate an output signal DOUT. A clock input CKIN is provided to both the first and second taps 102 and 104.

The control signal applied to the mixer 106 controls the weight between the DMAIN and DPOST signals that are combined in the mixer 106. Hence, the control signal determines the relative strength between the DMAIN and DPOST signals that are combined. Hence, the control signal may be viewed as providing filter coefficients for the FIR de-emphasis data driver. By way of example, when the control signal provides all weight to the DMAIN signal, the second tap 102 is effectively, disabled, and there is no de-emphasis.

In the data driver 100 of FIG. 1, the output DMAIN of the first tap 102 drives heavy loads posed by the second tap 104 and the mixer/driver 106. For high-speed data, with this heavy loading, output from a conventional (i.e., non-shunt peaking) CMOS flip-flop usually shows significant jitter increase at its data output because of speed limitation of the circuit. As a result, even for short reach applications (e.g., when the second tap 104 is completely turned off), the data quality at the output would still be degraded if a conventional CMOS flip-flop were used.

If the length of the physical channel is long, then the second tap 104 is turned on to cancel bandwidth-limiting effect of the channel. However, since the output of the first tap based on a conventional CMOS flip-flop would have considerable amount of jitter, the output of the second tap 104 would also be of degraded quality. As a result, the data quality at the far end would also be degraded. In addition, increased ISI at outputs of either taps will reduce an effective range of adjustment for de-emphasis level. By using inductive shunt peaking in the first tap 102, the inter symbol interference (ISI) of DMAIN can be significantly improved, thus improving the signal quality for both short-reach and long-reach applications. This is because ISI at anywhere along the data path degrades the overall performance, far-end or near-end.

The application of the present invention is not limited to the simple example described above. The exemplary embodiments of the present invention are very flexible when incorporating inductive shunt peaking into the FIR architecture. Depending on the data rate and jitter requirement, bandwidth of the data path can be further improved by applying the shunt peaking technique to other parts of the data path. For instance, inductors can be added in the second tap 104 to reduce the jitter in the DPOST signal. Further, shunt-peaking wide band buffers may be inserted between the taps and/or the mixer/driver to improve the data quality. In the mixer/driver, a shunt peaked load may also be used to replace the resistive load to further increase the bandwidth.

The shunt peaking of the present invention may also be applied at the receiving end of the data path. For linear channels, instead of or in addition to pre-emphasis (de-emphasis), post-emphasis at the receiver may be applied to cancel the high-frequency loss in the channel. The structure of the post-emphasis circuit is substantially the same as that of FIG. 1, and will not be described in detail. As a result, inductive shunt peaking can be readily applied to open the input data eye and generate data with reduced ISI.

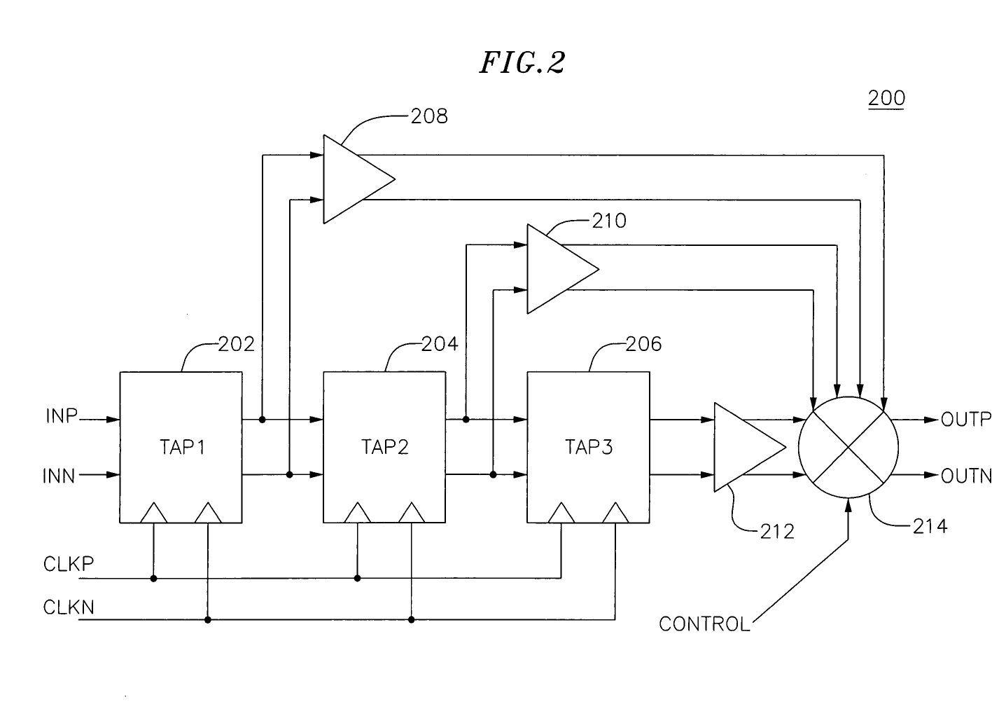

FIG. 2 is a three-tap FIR de-emphasis data driver 200 with shunt peaking in at least a first tap 202. The shunt peaking may also be provided in a second tap 204 and/or a third tap 206. The data driver 200 also includes a mixer 214. Each of the first, second and third taps 202, 204 and 206 includes a flip-flop. The three-tap shunt-peaked FIR de-emphasis data driver 200 may be used for high-speed applications.

The first tap 202 receives a differential pair of data inputs INP and INN, and outputs a differential pair of output signals that are provided to the second tap 204 and to the mixer 214 via a buffer 208. The second tap 204 receives the differential pair of output signals from the first tap 202, and outputs a differential pair of output signals. The differential pair of output signals from the second tap 204 are provided to the third tap 206 and to the mixer 214 via a buffer 210. The third tap 206 receives the differential pair of output signals from the second tap 204, and provides to the mixer via a buffer 212. The outputs of the first, second and third taps may be referred to as DPRE, DMAIN and DPOST signals, respectively, to designate their relative positions in the data driver 200. One or more of the buffers 208, 210 and 212 may employ inductive shunt peaking.

The mixer 214 is controlled by a control signal to generate a differential pair of output signals OUTP and OUTN. A differential pair of clock inputs CLKP and CLKN are provided to each of the first, second and third taps. The control signal applied to the mixer 214 controls the weight between the differential pairs of output signals from the first, second and third taps 202, 204 and 206 that are combined in the mixer 214. Hence, the control signal determines the relative weight between the outputs of the first, second and third taps. By way of example, when the control signal provides all weight to the signals from the first tap 202, there would be no de-emphasis. The mixer 214 may include circuitry for converting from voltage to current, such that the currents can be combined as weighted.

In the data driver 200 of FIG. 2, the differential pair of output signals of the first tap 202 drive heavy loads posed by the second tap 204 and the mixer/driver 214. For multi-gigabit data, output from a conventional (i.e., non-shunt peaking) CMOS flip-flop usually shows significant jitter increase at its data output because of speed limitation of the circuit. As a result, even for short reach applications (e.g., when the second and third taps 204 and 206 are completely turned off), the data quality at the output may still be degraded.

If the length of the physical channel is long, then the second tap 204 and/or the third tap 206 should be turned on to cancel bandwidth-limiting effect of the channel. However, since the output signals of the first tap based on a conventional CMOS flip-flop would have considerable amount of jitter, the output signals of the second tap 204 and the third tap 206 would also be of degraded quality. As a result, the data quality at the far end would also be degraded. ISI also reduces de-emphasis adjustment range. By using shunt-peaking in the first tap 202, the inter symbol interference (ISI) of its output signals can be significantly improved, thus improving the signal quality for both short-reach and long-reach applications.

Each of the taps 202, 204, 206 includes a flip-flop. Each of the flip-flops can be implemented using a latch such as a latch 300 of FIG. 3. Further, each of the taps 102 and 104 can be implemented using a single-ended (i.e., non-differential) half-circuit latch derived from the latch 300 as those skilled in the art would appreciate.

The latch 300 includes a pair of inductive elements 302 and 304 coupled between a supply voltage VDD and input transistors 310 and 312, respectively. The inductive elements 302 and 304 are coupled via resistors 306 and 308, respectively, to the input transistors 310 and 312, respectively. The input transistors 310 and 312 receive a differential pair of input signals DIP and DIN at their respective gate terminals. In other embodiments, the latches used for the taps 204, 206 and/or 104 may not include the inductive elements as these latches are used to implement the flip-flops that see less load than the latches used to implement the flip-flops of the taps 102 and 202, respectively.

The nodes between the resistors 306, 308 and the input transistors 310 and 312 are coupled to a differential pair of output signals QN and QP, respectively. The output signals QN and QP are also coupled to drain terminals of latch transistors 314 and 316, respectively. Further, a gate terminal of the latch transistor 314 is coupled to the output signal QP, and a gate terminal of the latch transistor 316 is coupled to the output signal QN.

Source terminals of the input transistors 310 and 312 are coupled to a drain terminal of a clock input transistor 318, and source terminals of the latch transistors 314 and 316 are coupled to a drain terminal of a clock input transistor 320. The clock input transistors 318 and 320 receive a differential pair of clock signals CKP and CKN, respectively, at their gate terminals. Source terminals of the clock input transistors 318 and 320 are coupled to a ground voltage VSS through a bias transistor 322. The bias transistor 322 receives at its gate terminal a bias voltage VBIAS, the level of which controls a tail current, and therefore the gain, of the latch 300.

All of the transistors illustrated in FIG. 3 are CMOS, and in particular NMOS transistors. In other embodiments, the transistors used may be PMOS or any other suitable transistors.

In the FIR-based de-emphasis data driver 200 of FIG. 2, the buffers 208, 210 and 212 are disposed in the signal paths between the taps and the mixer 214. In practice, the buffers can be provided anywhere in the signal path of the FIR de-emphasis data driver 200. One or more of the buffers in FIG. 2 may be implemented using a buffer circuit 350 illustrated in FIG. 4. Further, one or more of the buffers used may not include inductive elements that are shown and described in reference to FIG. 4. In addition, one or more single-ended half-circuits of the buffer 350 may be used in the FIR de-emphasis data driver 100 of FIG. 1. By way of example, a buffer that can be used in place of the buffer circuit 350 is disclosed in U.S. Pat. No. 6,624,699 entitled “Current-Controlled CMOS Wideband Data Amplifier Circuits,” the entire content of which is incorporated by reference herein.

The buffer circuit 350 includes a resistor 352 connected between a supply voltage VDD and a pair of inductive elements 354 and 356. The inductive elements 354 and 356 are also coupled to input transistors 362 and 364, respectively, via resistors 358 and 360, respectively. A node between the inductive element 354 and the resistor 358 provides one of a differential pair of output signals OUTN, and a node between the inductive element 356 and the resistor 360 provides the other one of the differential pair of output signals OUTP. The differential pair of outputs OUTN and OUTP are coupled to a ground voltage VSS through capacitors 378 and 380, respectively.

The input transistors 362 and 364 at their gate terminals receive a differential pair of input signals INP and INN, respectively. The gate terminal of the input transistor 362 is coupled through a capacitor 366 to a drain terminal of the input transistor 364. The gate terminal of the input transistor 364 is coupled through a capacitor 368 to a drain of the input transistor 362. Source terminals of the input transistors 362 and 364 are coupled to a ground voltage VSS through a bias transistor 376. The bias transistor 376 receives at its gate terminal a bias voltage VBIAS, the level of which controls a tail current, and therefore the gain, of the buffer 350.

As described above, the inductive shunt peaking implemented in the FIR de-emphasis data driver in exemplary embodiments of the present invention may result in increased bandwidth, optimization of group delay and/or improved data integrity at far-end and near-end of the transmission medium. By way of example, the data driver implemented using 0.13 μm CMOS technology may be able to support data rates of 5 Gbps to 6 Gbps. When the inductive shunt peaking is used, the data rates of 10 Gbps may be supported using the 0.13 μm CMOS technology. The inductive shunt peaking may also be applied to other technologies (e.g., 0.09 μm CMOS technology) to realize similar improvements. Hence, the limits of a given CMOS technology, for example, may be extended significantly.

While certain exemplary embodiments have been described above in detail and shown in the accompanying drawings, it is to be understood that such embodiments are merely illustrative of and not restrictive of the broad invention. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as defined by the appended claims.

1. A finite impulse response (FIR) de-emphasis data driver for a data transmitter or a receiver, comprising:
a first tap for receiving a data input, and for generating a first output, the first tap having at least one shunt peaking inductor;
a second tap for receiving the first output, and for generating a second output; and
a mixer for combining the first output and the second output to generate a driver output.

2. The FIR de-emphasis data driver of claim 1, further comprising a clock for providing a clock signal to the first tap and the second tap.

3. The FIR de-emphasis data driver of claim 1, wherein the first tap comprises an input transistor for receiving the data input, wherein said at least one shunt peaking inductor is disposed between the input transistor and a supply voltage.

4. The FIR de-emphasis data driver of claim 1, wherein each of the first tap and the second tap comprises a flip-flop.

5. The FIR de-emphasis data driver of claim 1, wherein at least one of the second tap and the mixer includes at least one shunt peaking inductor.

6. The FIR de-emphasis data driver of claim 1, wherein the FIR de-emphasis data driver is implemented using a CMOS technology.

7. The FIR de-emphasis data driver of claim 1, further comprising a third tap for receiving the second output, and for generating a third output that are mixed by the mixer together with the first and second outputs to generate the driver output.

8. The FIR de-emphasis data driver of claim 7, wherein the third tap includes at least one shunt peaking inductor.

9. The FIR de-emphasis data driver of claim 1, further comprising at least one inductive shunt peaked buffer disposed between the mixer and at least one of the first tap and the second tap.

10. The FIR de-emphasis data driver of claim 1, wherein each of the data input, first output, second output and the driver output includes a differential pair of signals.

11. The FIR de-emphasis data driver of claim 1, wherein the mixer receives a control signal, which is used to determine relative weights of the first output and the second output when combining them to generate the driver output.

12. A method of maintaining near-end and far-end signal integrity of a data transmitter, comprising:
receiving a data input into a first tap having at least one shunt peaking inductor;
generating a first output in the first tap;
receiving the first output into a second tap;
generating a second output in the second tap; and
combining the first output and the second output to generate a driver output.

13. The method of claim 12, further comprising providing a clock signal to the first tap and the second tap.

14. The method of claim 12, further comprising receiving the data input at an input transistor of the first tap, wherein said at least one shunt peaking inductor is disposed between the input transistor and a supply voltage.

15. The method of claim 12, wherein each of the first tap and the second tap comprises a flip-flop.

16. The method of claim 12, wherein the second tap includes at least one shunt peaking inductor.

17. The method of claim 12, further comprising:
receiving the second output into a third tap; and
generating a third output in the third tap, wherein said combining comprises combining the first output, the second output and the third output to generate the driver output.

18. The method of claim 17, wherein the third tap includes at least one shunt peaking inductor.

19. The method of claim 12, further comprising buffering at least one of the first output and the second output in an inductive shunt peaked buffer prior to combining them.

20. The method of claim 12, wherein each of the data input, first output, second output and the driver output includes a differential pair of signals.
